(19) United States
(12) Patent Application Publication
(10) Pub. No.: US 2021/0172309 A1
(43) Pub. Date: Jun. 10, 2021

(54) Chem Skid

(71) Applicant: Seth Ren Sawyer, Iraan, TX (US)

(72) Inventor: Seth Ren Sawyer, Iraan, TX (US)

(21) Appl. No.: 17/093,623

(22) Filed: Nov. 9, 2020

Related U.S. Application Data
(60) Provisional application No. 62/932,496, filed on Nov. 7, 2019.

(51) Int. Cl. E21B 43/26; F04D 13/02; F04D 13/16; B65D 88/54

(52) U.S. Cl. CPC E21B 43/2607; B65D 88/54; F04D 13/16; F04D 13/02

(57) ABSTRACT

A multi-tank recirculating chemical fluid storage system for receiving and managing one or more fluids at multiple stage frac jobs. The multi-tank recirculating chemical fluid storage system comprises a support frame, a chemical tank, and a water manifold. The multi-tank recirculating chemical fluid storage system is configured to recirculating and agitate fluids in the chemical tank with pumps to reduce any settlement and keep precipitates to a minimum. The multi-tank recirculating chemical fluid storage system comprises a plumbing assembly, one or more pumps, and a drive system. The support frame comprises a front end, a rear end, a first side, and a second side.

### CROSS-REFERENCE TO RELATED APPLICATIONS

This application claims benefit to U.S. Patent Application No. 62/932,496, filed on Nov. 7, 2019.

### STATEMENT REGARDING FEDERALLY SPONSORED RESEARCH OR DEVELOPMENT (IF APPLICABLE)

Not applicable.

### REFERENCE TO SEQUENCE LISTING, A TABLE, OR A COMPUTER PROGRAM LISTING COMPACT DISC APPENDIX (IF APPLICABLE)

Not applicable.

### BACKGROUND OF THE INVENTION

No relevant prior art is known to the Applicant.

### BRIEF SUMMARY OF THE INVENTION

A multi-tank recirculating chemical fluid storage system for receiving and managing one or more fluids at multiple stage frac jobs. Said multi-tank recirculating chemical fluid storage system comprises a support frame, a chemical tank, and a water manifold. Said multi-tank recirculating chemical fluid storage system is configured to recirculating and agitate fluids in said chemical tank with pumps to reduce any settlement and keep precipitates to a minimum. Said multi-tank recirculating chemical fluid storage system comprises a plumbing assembly, one or more pumps, and a drive system. Said support frame comprises a front end, a rear end, a first side, and a second side.

### BRIEF DESCRIPTION OF THE SEVERAL VIEWS OF THE DRAWING

FIG. 1A illustrates an overview of a worksite 100.

FIG. 1B illustrates an ISO tank 102.

FIG. 2 illustrates an elevated top view of a multi-tank recirculating chemical fluid storage system 200.

FIG. 3 illustrates a rear perspective view of said multi-tank recirculating chemical fluid storage system 200.

FIG. 4 illustrates a perspective overview of said multi-tank recirculating chemical fluid storage system 200.

FIG. 5 illustrates am perspective overview of a first fitting 500 among one or more vented fittings 210.

FIGS. 6A, and 6B illustrate an elevated top view and a perspective overview of a front half 600 of said multi-tank recirculating chemical fluid storage system 200, displaying one or more pumps 218 and a drive system 220.

FIGS. 7A, and 7B illustrate an elevated top view and a detailed perspective overview of a front mounting platform 400 with a plumbing assembly 216, said drive system 220 and said one or more pumps 218.

FIGS. 8A, 8B, and 8C illustrate a lower perspective view of said multi-tank recirculating chemical fluid storage system 200 with a central plumbing call-out 800, a detailed view of said central plumbing call-out 800, and an elevated side view of a handle assembly 802.

FIG. 9 illustrates a perspective second side view of said multi-tank recirculating chemical fluid storage system 200 with a second compartment fluid line 900.

FIG. 10 illustrates a perspective view of a first lower plumbing assembly 1000 and a second lower plumbing assembly 1002.

FIG. 11 illustrates a perspective overview of a second side 228 of a front end 222 including a control panel 1100.

FIG. 12 illustrates a perspective overview of a first side 226 of said front end 222 including said control panel 1100.

### DETAILED DESCRIPTION OF THE INVENTION

The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

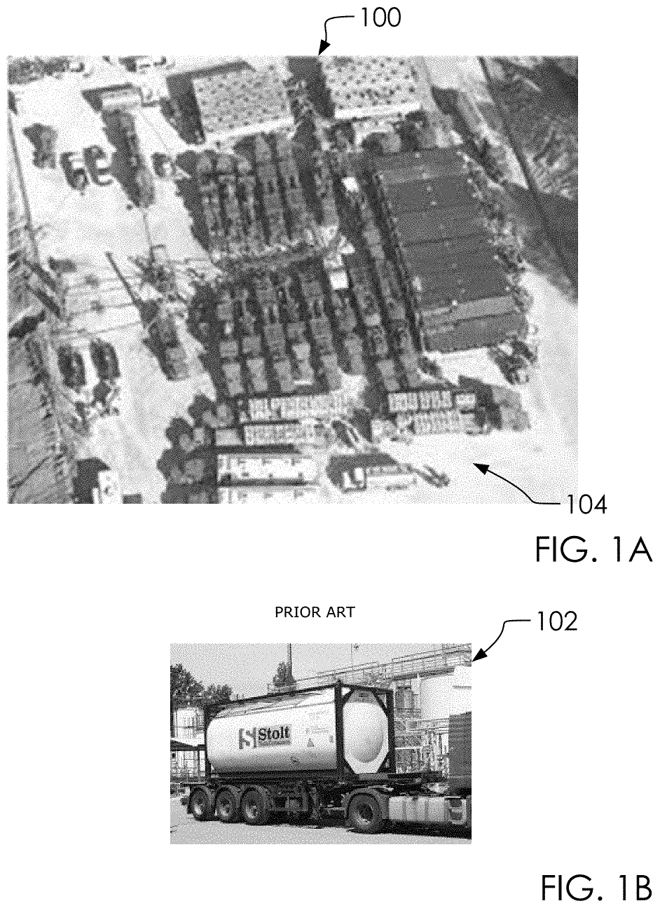

FIG. 1A illustrates an overview of a worksite 100.

Large multiple stage frac jobs currently necessitate many pieces of primary equipment on each location. In addition, large numbers of pumps and auxiliary equipment are necessary to perform a proper frac job. Huge volumes of Friction Reducers (“FR”) and other necessary chemicals are needed to mix with the water and pump downhole. Positioning the many pieces of equipment needed at the site to handle large quantities of chemicals often becomes a real issue. Many times, operators cannot get certain chemicals close enough and must string out long hoses to reach the chemical pumps.

Said worksite 100 comprises an image of a frac spread giving an indication of all the necessary mobile equipment. Wherein, said worksite 100 shows a chemical equipment 104 at the bottom of the picture. Said chemical equipment 104 are taking up lots of space and must be pumped a long way to the blender.

Operators have started using iso tanks to hold these chemicals. Each iso tank holds about 5000 gallons. They can be hauled to the location and dropped off next to pumps. However, these do not have any recirculation, become contaminated, and have large number of precipitants form inside these tanks. FR can settle and form large precipitant solids that cannot be pumped properly.

FIG. 1B illustrates an ISO tank 102.

Said ISO tank 102 can comprise a prior art system.

Said ISO tank 102 are not designed to be properly cleaned and take up needed space on a frac location.

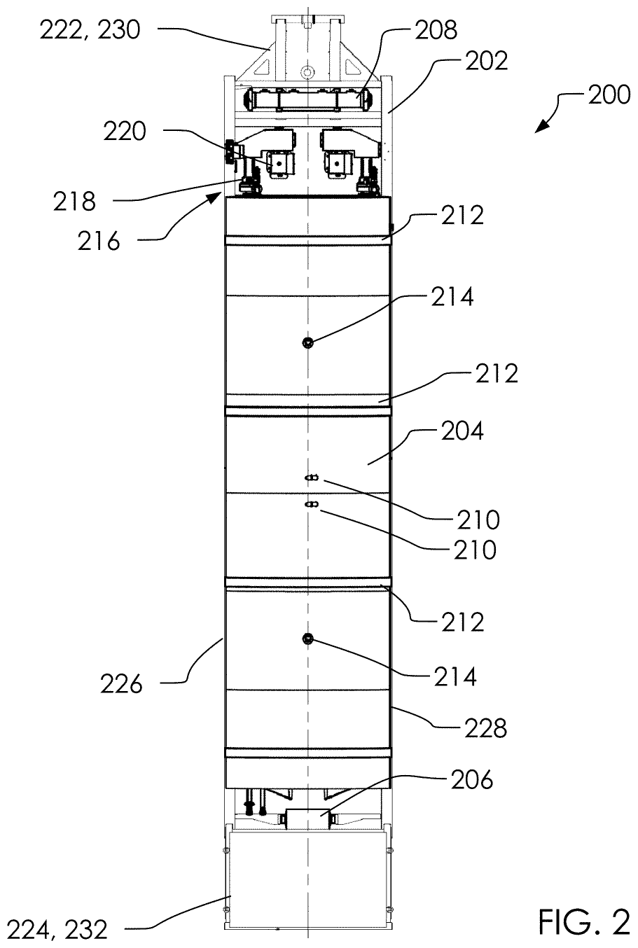

FIG. 2 illustrates an elevated top view of a multi-tank recirculating chemical fluid storage system 200.

In one embodiment, said multi-tank recirculating chemical fluid storage system 200 can comprise a support frame 202 (also known as a skid), a chemical tank 204, an air tank 206, a water manifold 208

In one embodiment, said multi-tank recirculating chemical fluid storage system 200 can be placed in the middle of said worksite 100 right next to an acid skid. Said multi-tank recirculating chemical fluid storage system 200 can eliminate two of the frac tanks in the middle of said worksite 100. Said multi-tank recirculating chemical fluid storage system 200 can be placed right next to the blender and or the chemical pumps. Said multi-tank recirculating chemical fluid storage system 200 can unload the FR and other chemicals from iso tank or trucks at the back of the skids to keep them full. This will eliminate all the space needed for the chemicals.

Said multi-tank recirculating chemical fluid storage system 200 can be configured to recirculating and agitate fluids in said chemical tank 204 with pumps to reduce any settlement and keep precipitates to a minimum.

In one embodiment, fluids pumped in said multi-tank recirculating chemical fluid storage system 200 can be filtered.

Advantages of said multi-tank recirculating chemical fluid storage system 200 over the prior art include its placement and arrangement in said worksite 100. For example, said worksite 100 can fit neatly within the frac tank spread and will help reduce the needed frac pad size.

Said multi-tank recirculating chemical fluid storage system 200 can keep fluids agitated with circulating pumps. Said multi-tank recirculating chemical fluid storage system 200 can eliminate long hoses to chemical pumps. Said multi-tank recirculating chemical fluid storage system 200 can greatly improve the quality control of chemicals added to frac waters. Said multi-tank recirculating chemical fluid storage system 200 can utilize safe containers for all chemicals.

Consequently, said multi-tank recirculating chemical fluid storage system 200 can reduce maintenance and equipment costs, as well as improve portability.

Said multi-tank recirculating chemical fluid storage system 200 can comprise one or more vented fittings 210, one or more tank straps 212, one or more flowline ultrasonic level transmitters 214, a plumbing assembly 216, one or more pumps 218, and a drive system 220.

Said support frame 202 can comprise a front end 222, a rear end 224, a first side 226, a second side 228, a trailer hitch 230, and a trailer wheel assembly 232.

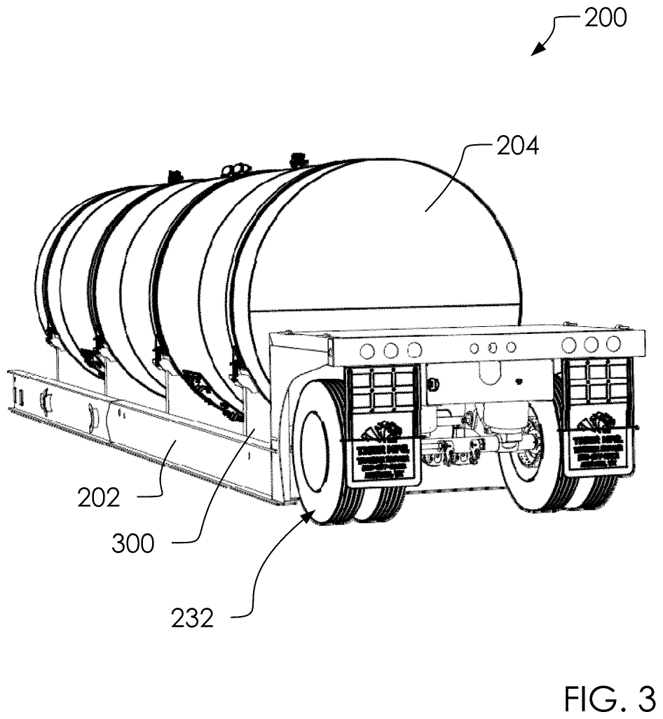

FIG. 3 illustrates a rear perspective view of said multi-tank recirculating chemical fluid storage system 200.

In one embodiment, said multi-tank recirculating chemical fluid storage system 200 can be mounted to said support frame 202 and function as a trailer on said trailer hitch 230 and said trailer wheel assembly 232. Accordingly, said multi-tank recirculating chemical fluid storage system 200 can be transported as any other semi-trailer and placed into service with ease.

Said chemical tank 204 can be secured to said support frame 202 with a plurality of tank support assemblies and a plurality of tank support assemblies 300 and said one or more tank straps 212.

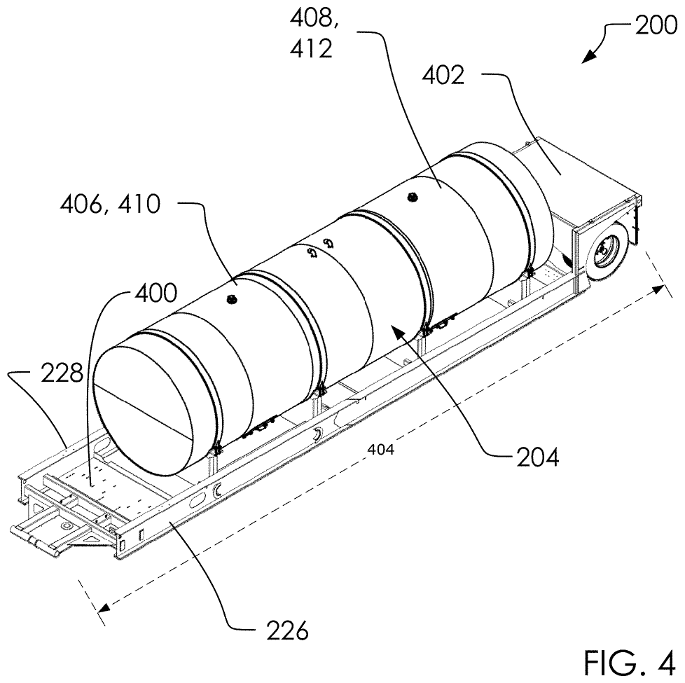

FIG. 4 illustrates a perspective overview of said multi-tank recirculating chemical fluid storage system 200.

Said multi-tank recirculating chemical fluid storage system 200 can comprise a front mounting platform 400, a rear platform 402 and a length 404.

In one embodiment, said chemical tank 204 can comprise a first compartment 406 and a second compartment 408. Accordingly, said chemical tank 204 can be used to hold and process a first fluid 410 and a second fluid 412.

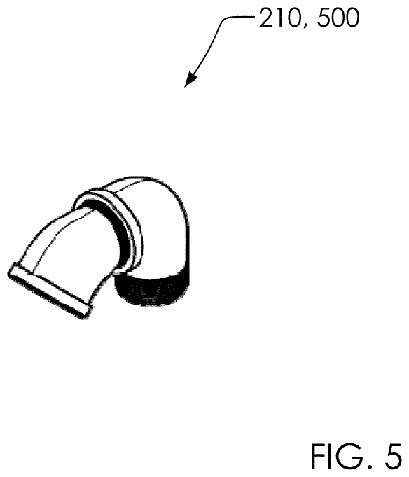

FIG. 5 illustrates am perspective overview of a first fitting 500 among said one or more vented fittings 210.

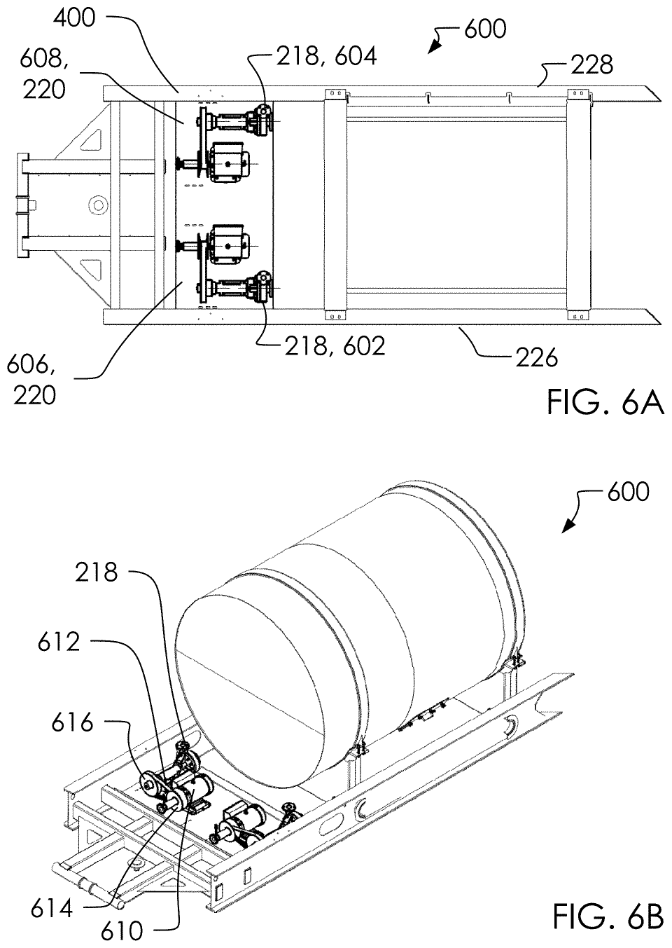

FIGS. 6A, and 6B illustrate an elevated top view and a perspective overview of a front half 600 of said multi-tank recirculating chemical fluid storage system 200, displaying said one or more pumps 218 and said drive system 220.

In one embodiment, said first side 226 and said second side 228 of said front mounting platform 400 can each comprise an independent pump, drive and plumbing system. Accordingly, said one or more pumps 218 can comprise a first pump 602 and a second pump 604; and said drive system 220 can comprise a first drive system 606 and a second drive system 608.

Each among said drive system 220 can comprise a motor 610, a belt 612, and a motor pulley 614. Each among said one or more pumps 218 can comprise a pump pulley 616. Said motor 610 can drive said motor pulley 614, which can transfer power through said belt 612 onto said pump pulley 616 so as to activate the respective pump among said one or more pumps 218.

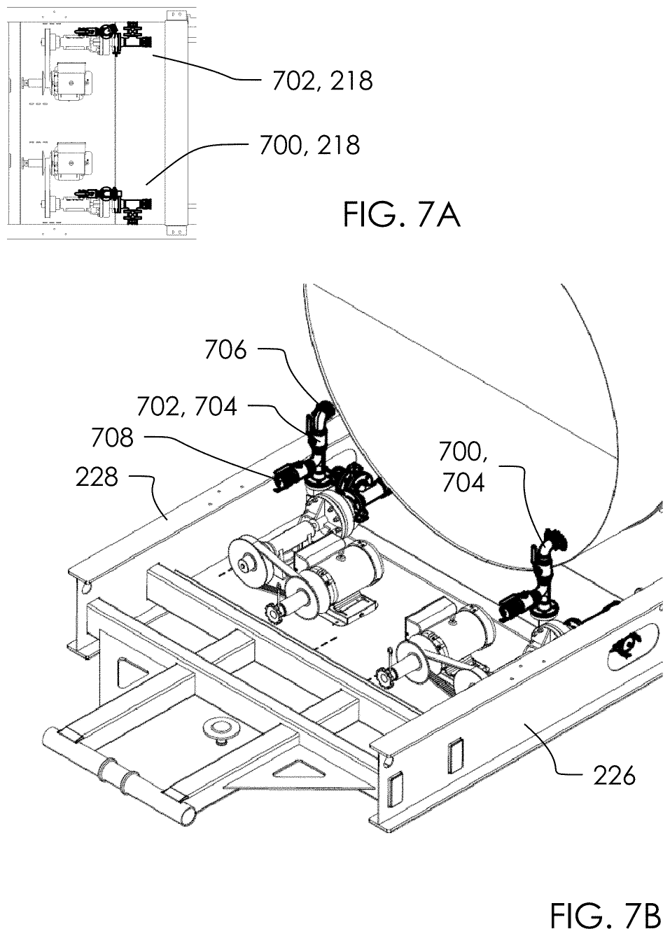

FIGS. 7A, and 7B illustrate an elevated top view and a detailed perspective overview of said front mounting platform 400 with said plumbing assembly 216, said drive system 220 and said one or more pumps 218.

As noted above, said plumbing assembly 216 can comprise a first plumbing assembly 700 and a second plumbing assembly 702.

Each among said plumbing assembly 216 can comprise attachments connected between said one or more pumps 218 and said chemical tank 204. Each said plumbing assembly 216 can comprise one or more lines and valves 704 to control a fluid movement between an inlet 706 and an outlet 708. In one embodiment, said inlet 706 and said outlet 708 can comprise couplings for selectively holding lines in fluid connection with said one or more pumps 218.

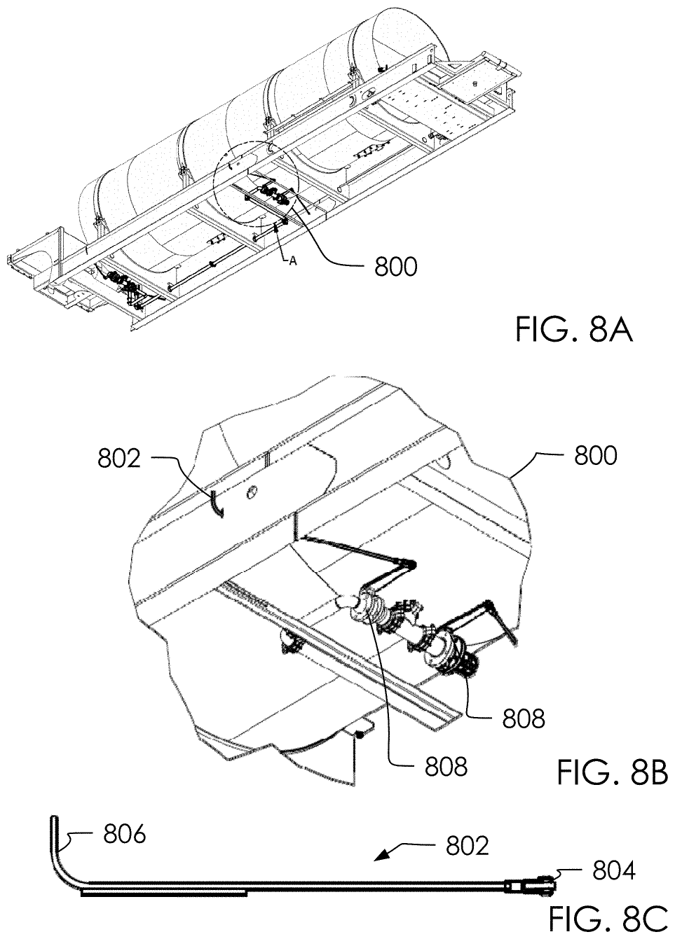

FIGS. 8A, 8B, and 8C illustrate a lower perspective view of said multi-tank recirculating chemical fluid storage system 200 with a central plumbing call-out 800, a detailed view of said central plumbing call-out 800, and an elevated side view of a handle assembly 802.

In one embodiment, said handle assembly 802 can be attached to a portion of said central plumbing call-out 800 and penetrate through a portion of said support frame 202. Said handle assembly 802 can comprise a jam nut 804 attached to a portion of said central plumbing call-out 800; wherein, pulling a handle portion 806 of said handle assembly 802 can cause a valve 808 to selectively open or close.

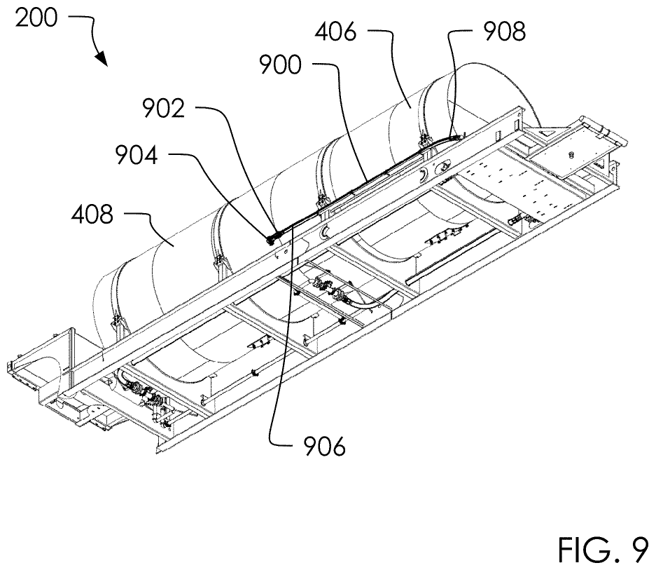

FIG. 9 illustrates a perspective second side view of said multi-tank recirculating chemical fluid storage system 200 with a second compartment fluid line 900.

In one embodiment, said second compartment 408 can be connected to said second pump 604 and said second plumbing assembly 702 through said second compartment fluid line 900. In one embodiment, a valve 902 can connect to said valve 902 and then a second compartment inlet 904 into said second compartment 408 at a first end 906 and said second plumbing assembly 702 at a second end 908.

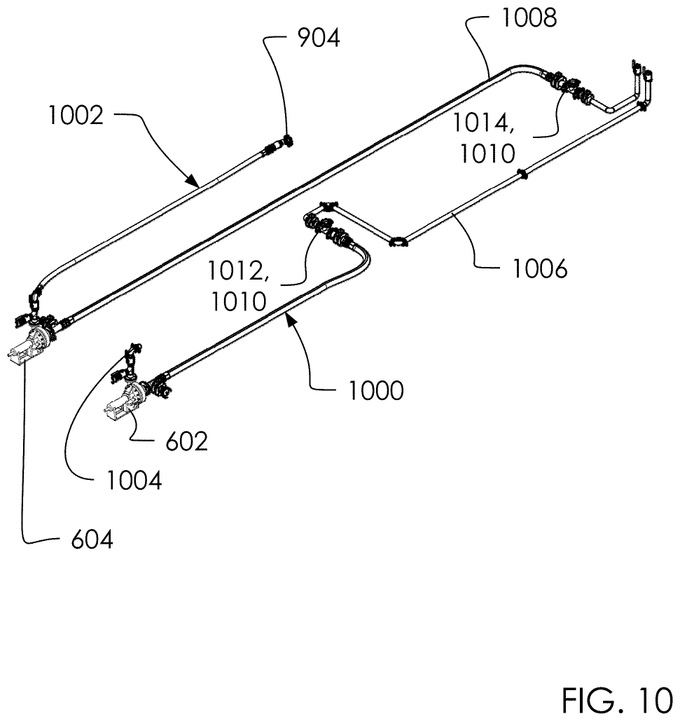

FIG. 10 illustrates a perspective view of a first lower plumbing assembly 1000 and a second lower plumbing assembly 1002.

In one embodiment, said first lower plumbing assembly 1000 can attach to said first compartment 406 and said second lower plumbing assembly 1002 can attach to said second compartment 408.

In one embodiment, said first lower plumbing assembly 1000 can comprise a first compartment inlet line 1004 for connecting said first pump 602 with said first compartment 406.

In one embodiment, said first lower plumbing assembly 1000 can comprise a first mineral line 1006, and said second lower plumbing assembly 1002 can comprise a second mineral line 1008.

Each of said first compartment 406 and said second compartment 408 can comprise a mineral fluid inlet 1010 in a lower portion of each respective tank; a first mineral fluid inlet 1012 in said first lower plumbing assembly 1000 and a second mineral inlet 1014 in said second lower plumbing assembly 1002. Accordingly, said first compartment 406 can have two fluid inlets said first mineral fluid inlet 1012 and said first compartment inlet line 1004; and said second compartment 408 can comprise said second compartment inlet 904 and said second mineral inlet 1014. Thereby, said one or more pumps 218 can selectively fill, drain and churn fluids within said chemical tank 204 and more precisely, within said first compartment 406 and said second compartment 408. Likewise, said mineral fluid inlet 1010 can be manually operated using said handle assembly 802 as discussed above.

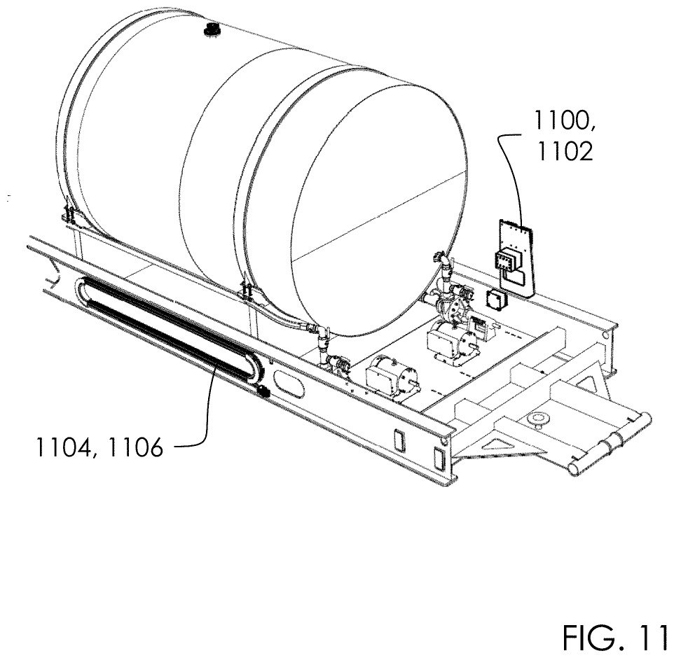

FIG. 11 illustrates a perspective overview of said second side 228 of said front end 222 including a control panel 1100.

In one embodiment, said multi-tank recirculating chemical fluid storage system 200 can comprise said control panel 1100 and/or a controller 1102 for operating each among said plumbing assembly 216, said one or more pumps 218, said drive system 220, said first lower plumbing assembly 1000 and said second lower plumbing assembly 1002.

Likewise, a power cable 1104, and a power source 1106 may be required to operate said multi-tank recirculating chemical fluid storage system 200, as is known in the art.

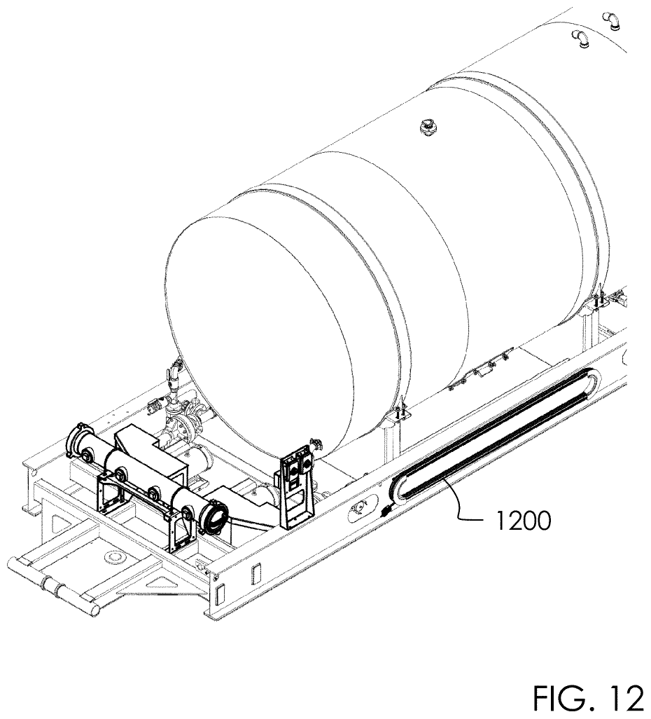

FIG. 12 illustrates a perspective overview of said first side 226 of said front end 222 including said control panel 1100.

A first side power cable 1200 may be required for said first drive system 606.

The following listing of parts is included for the convenience of the reader:
said worksite 100,
said ISO tank 102,
said chemical equipment 104,
said multi-tank recirculating chemical fluid storage system 200,
said support frame 202,
said chemical tank 204,
said air tank 206,
said water manifold 208,
said one or more vented fittings 210,
said one or more tank straps 212,
said one or more flowline ultrasonic level transmitters 214,
said plumbing assembly 216,
said one or more pumps 218,
said drive system 220,
said front end 222,
said rear end 224,
said first side 226,
said second side 228,
said trailer hitch 230,
said trailer wheel assembly 232,
said plurality of tank support assemblies 300,
said front mounting platform 400,
said rear platform 402,
said length 404,
said first compartment 406,
said second compartment 408,
said first fluid 410,
said second fluid 412,
said first fitting 500,
said front half 600,
said first pump 602,
said second pump 604,
said first drive system 606,
said second drive system 608,
said motor 610,
said belt 612,
said motor pulley 614,
said pump pulley 616,
said first plumbing assembly 700,
said second plumbing assembly 702,
said one or more lines and valves 704,
said inlet 706,
said outlet 708,
said central plumbing call-out 800,
said handle assembly 802,
said jam nut 804,
said handle portion 806,
said valve 808,
said second compartment fluid line 900,
said valve 902,
said second compartment inlet 904,
said first end 906,
said second end 908,
said first lower plumbing assembly 1000,
said second lower plumbing assembly 1002,
said first compartment inlet line 1004,
said first mineral line 1006,
said second mineral line 1008,
said mineral fluid inlet 1010,
said first mineral fluid inlet 1012,
said second mineral inlet 1014,
a power cable 1016,
a power source 1018,
said control panel 1100,
said controller 1102,
said power cable 1104,
said power source 1106, and
said first side power cable 1200.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A multi-tank recirculating chemical fluid storage system for receiving and managing one or more fluids at multiple stage frac jobs, wherein:
said multi-tank recirculating chemical fluid storage system comprises a support frame, a chemical tank, and a water manifold;
said multi-tank recirculating chemical fluid storage system is configured to recirculating and agitate fluids in said chemical tank with pumps to reduce any settlement and keep precipitates to a minimum;
said multi-tank recirculating chemical fluid storage system comprises a plumbing assembly, one or more pumps, and a drive system; and
said support frame comprises a front end, a rear end, a first side, and a second side.

2. The multi-tank recirculating chemical fluid storage system of claim 1, wherein:
said support frame comprises a trailer hitch, and a trailer wheel assembly.

3. The multi-tank recirculating chemical fluid storage system of claim 2, wherein:
said multi-tank recirculating chemical fluid storage system is mounted to said support frame and function as a trailer on said trailer hitch and said trailer wheel assembly; and
Accordingly, said multi-tank recirculating chemical fluid storage system is transported as any other semi-trailer and placed into service with ease.

4. The multi-tank recirculating chemical fluid storage system of claim 3, wherein:
said chemical tank is secured to said support frame with a plurality of tank support assemblies and a plurality of tank support assemblies and one or more tank straps.

5. The multi-tank recirculating chemical fluid storage system of claim 4, wherein:
said chemical tank comprises a first compartment and a second compartment; and
Accordingly, said chemical tank is used to hold and process a first fluid and a second fluid.

6. The multi-tank recirculating chemical fluid storage system of claim 5, wherein:
said first side and said second side of a front mounting platform is configured to each comprise an independent pump, drive and plumbing system;
said one or more pumps comprises a first pump and a second pump; and
said drive system comprises a first drive system and a second drive system.

7. The multi-tank recirculating chemical fluid storage system of claim 6, wherein:
each among said drive system comprises a motor, a belt, and a motor pulley;
each among said one or more pumps comprises a pump pulley; and
said motor is configured to drive said motor pulley, which is configured to transfer power through said belt onto said pump pulley so as to activate the respective pump among said one or more pumps.

8. The multi-tank recirculating chemical fluid storage system of claim 7, wherein:
said second compartment is connected to said second pump and a second plumbing assembly through a second compartment fluid line; and
a valve is configured to connect to said valve and then a second compartment inlet into said second compartment at a first end and said second plumbing assembly at a second end.

9. The multi-tank recirculating chemical fluid storage system of claim 8, wherein:
a first lower plumbing assembly is configured to attach to said first compartment and a second lower plumbing assembly is configured to attach to said second compartment;
said first lower plumbing assembly comprises a first compartment inlet line for connecting said first pump with said first compartment;
said first lower plumbing assembly comprises a first mineral line, and said second lower plumbing assembly comprises a second mineral line;
each of said first compartment and said second compartment comprises a mineral fluid inlet in a lower portion of each respective tank; a first mineral fluid inlet in said first lower plumbing assembly and a second mineral inlet in said second lower plumbing assembly;
said first compartment is configured to have two fluid inlets said first mineral fluid inlet and said first compartment inlet line; said second compartment comprises said second compartment inlet and said second mineral inlet;
said one or more pumps is configured to selectively fill, drain and churn fluids within said chemical tank and more precisely, within said first compartment and said second compartment; and
said mineral fluid inlet is manually operated using a handle assembly as discussed above.

10. The multi-tank recirculating chemical fluid storage system of claim 9, wherein:
said multi-tank recirculating chemical fluid storage system comprises a control panel and a controller for operating each among said plumbing assembly, said one or more pumps, said drive system, said first lower plumbing assembly and said second lower plumbing assembly.
